(19) United States
(12) Patent Application Publication
(10) Pub. No.: US 2016/0011944 A1
(43) Pub. Date: Jan. 14, 2016

(54) STORAGE AND RECOVERY OF DATA OBJECTS

(71) Applicant: International Business Machines Corporation, Armonk, NY (US)

(72) Inventors: Anket Jain, Sagar (IN); Rajat R. Verma, Bangalore (IN)

(21) Appl. No.: 14/327,626

(22) Filed: Jul. 10, 2014

(51) Int. Cl. G06F 11/14; G06F 17/30

(52) U.S. Cl. CPC G06F 11/1402; G06F 17/3053; G06F 17/3087

(57) ABSTRACT

Storing and recovering data objects is provided. A first data object is stored to a first storage system. The first data object includes user data. A score of the first data object is determined. The score of the first data object represents an importance of the first data object. Responsive to determining that the score of the first data object exceeds a threshold, a second data object is stored to a second storage system. The second data object includes the user data. A first reference database a reference of the second data object and the first data object is stored to a first reference database.

### BACKGROUND OF THE INVENTION

The present invention relates generally to the field of data backup and recovery, and more particularly to storage and recovery of data objects.

Object storage is a storage architecture that manages data as objects. Conversely, file systems manage data as a file hierarchy, and block storage manages data as blocks within sectors and tracks. Object storage may also be known as object-based storage. Each object typically includes the data itself (e.g., user data), a variable amount of metadata, and a globally unique identifier. Metadata is data about data. Metadata typically describes the content of or characteristics of data.

A globally unique identifier (GUID) is a unique sequence of characters used as an identifier by computer software. A GUID is usually stored as a 128-bit value that can be represented by 32 hexadecimal digits. The hexadecimal digits can be displayed in groups separated by hyphens. GUIDs can be generated randomly, by a predictable methodology, or some combination thereof.

Data replication is used to make a copy of data belonging to multiple nodes from one server to another server, so that if the main source server to which data is being backed-up goes down, the clients can recover their data from the replication site. A storage-management server stores data objects in one or more storage pools and uses a database for tracking metadata about the stored objects. The storage management server may replicate the data objects to a remote location for disaster recovery purposes. Some of the methods used to transfer data to a remote location include physically transporting tapes containing copies of the data from the source site to the disaster recovery site, electronically transmitting the data (e.g., via export/import) or using hardware replication of the source site disk storage to create a mirror of the data. Available replication hardware devices include products that perform block-level replication using deduplication hardware.

### SUMMARY

According to one embodiment of the present disclosure, a method for storing and recovering data objects is provided. The method includes storing, by one or more processors, a first data object to a first storage system, wherein the first data object includes user data; determining, by one or more processors, a score of the first data object, wherein the score of the first data object represents an importance of the first data object; responsive to determining, by one or more processors, that the score of the first data object exceeds a threshold, storing, by one or more processors, a second data object to a second storage system, wherein the second data object includes the user data; and storing, by one or more processors, to a first reference database a reference of the second data object and the first data object.

According to another embodiment of the present disclosure, a computer program product for storing and recovering data objects is provided. The computer program product comprises a computer readable storage medium and program instructions stored on the computer readable storage medium. The program instructions include program instructions to store a first data object to a first storage system, wherein the first data object includes user data; program instructions to determine a score of the first data object, wherein the score of the first data object represents an importance of the first data object; program instructions to, responsive to determining that the score of the first data object exceeds a threshold, store a second data object to a second storage system, wherein the second data object includes the user data; and program instructions to store to a first reference database a reference of the second data object and the first data object.

According to another embodiment of the present disclosure, a computer system for storing and recovering data objects is provided. The computer system includes one or more computer processors, one or more computer readable storage media, and program instructions stored on the computer readable storage media for execution by at least one of the one or more processors. The program instructions include program instructions to store a first data object to a first storage system, wherein the first data object includes user data; program instructions to determine a score of the first data object, wherein the score of the first data object represents an importance of the first data object; program instructions to, responsive to determining that the score of the first data object exceeds a threshold, store a second data object to a second storage system, wherein the second data object includes the user data; and program instructions to store to a first reference database a reference of the second data object and the first data object.

### BRIEF DESCRIPTION OF THE DRAWINGS

FIG. 1 is a functional block diagram illustrating a computing environment, in accordance with an embodiment of the present disclosure;

FIG. 2 is a flowchart depicting operations for data object storage, on a computing device within the computing environment of FIG. 1, in accordance with an embodiment of the present disclosure;

FIG. 3 is a flowchart depicting operations for data object recovery, on a computing device within the computing environment of FIG. 1, in accordance with an embodiment of the present disclosure; and

FIG. 4 is a block diagram of components of a computing device executing operations for storage and recovery of data objects, in accordance with an embodiment of the present disclosure.

### DETAILED DESCRIPTION

Embodiments of the present disclosure provide storage and recovery of data objects. Some embodiments provide replicating objects based on a score of the object. Some embodiments provide recovery of objects based on references to objects stored by datacenters.

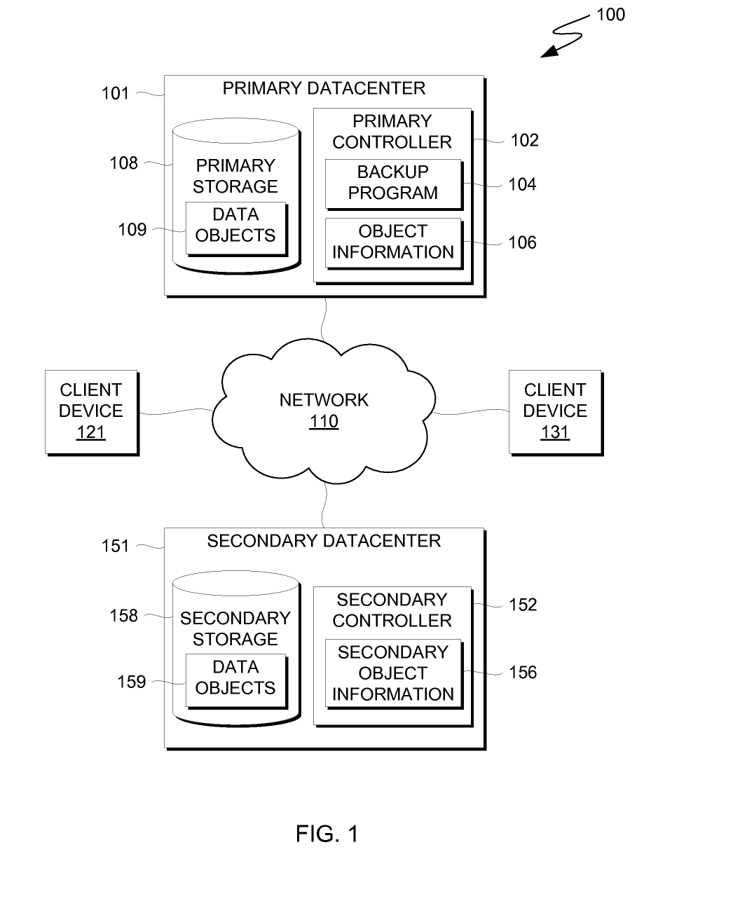

The present disclosure will now be described in detail with reference to the Figures. FIG. 1 is a functional block diagram illustrating a computing environment, in accordance with an embodiment of the present disclosure. For example, FIG. 1 is a functional block diagram illustrating computing environment 100. Computing environment 100 includes primary datacenter 101, client device 121, client device 131, and secondary datacenter 151, interconnected over network 110. Primary datacenter 101 includes primary storage 108, which includes data objects 109, and primary controller 102, which includes backup program 104 and object information 106. Secondary datacenter 151 includes secondary storage 158, which includes data objects 159, and secondary controller 152, which includes secondary object information 156.

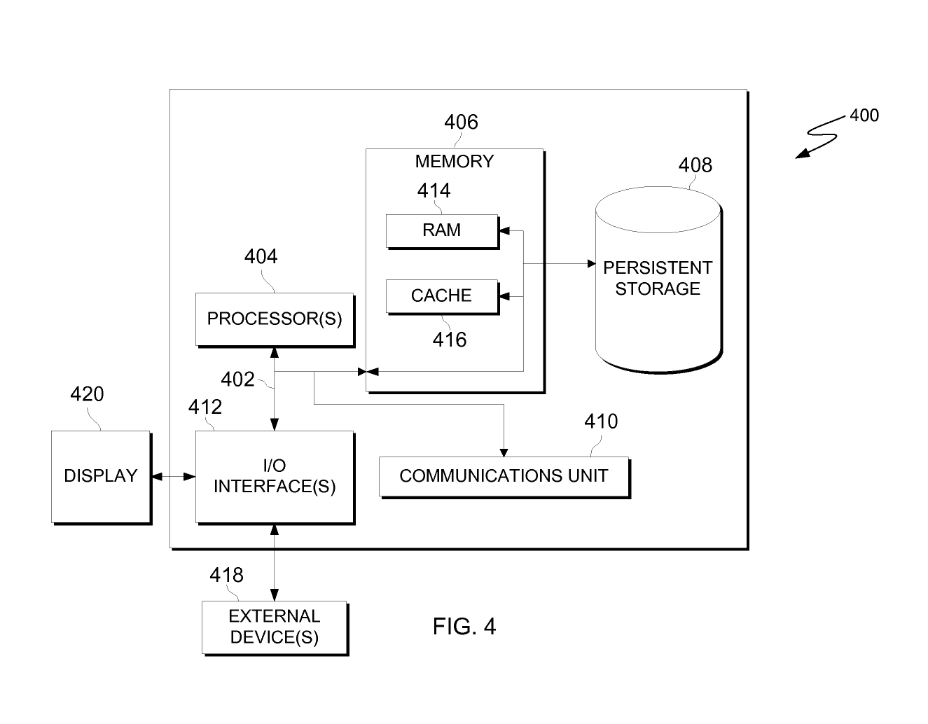

In various embodiments of the present invention, each of primary controller 102, client device 121, client device 131, and secondary controller 152 is a computing device that can be a standalone device, a server, a laptop computer, a tablet computer, a netbook computer, a personal computer (PC), or a desktop computer. In another embodiment, each of primary controller 102, client device 121, client device 131, and secondary controller 152 represents a computing system utilizing clustered computers and components to act as a single pool of seamless resources. In general, each of primary controller 102, client device 121, client device 131, and secondary controller 152 can be any computing device or a combination of devices with access to primary storage 108, data objects 109, secondary storage 158, data objects 159, object information 106, secondary object information 156, and each other of primary controller 102, client device 121, client device 131, and secondary controller 152, and capable of executing backup program 104. Each of primary controller 102, client device 121, client device 131, and secondary controller 152 may include internal and external hardware components, as depicted and described in further detail with respect to FIG. 4.

In this example embodiment, backup program 104 is stored on primary controller 102. In other embodiments, backup program 104 may reside on another computing device, provided that backup program 104 can access data objects 109, object information 106, data objects 159, and secondary object information 156. In other embodiments, backup program 104 may be stored externally and accessed through a communication network, such as network 110.

In some embodiments, an instance of backup program 104 is stored on secondary controller 152. In this case, the instance of backup program 104 of secondary controller 152 includes the functionality and operability described herein in connection with backup program 104. In some embodiments, the instance of backup program 104 of secondary controller 152 becomes active in response to detecting a failure of one or both of primary datacenter 101 and primary controller 102. In one such embodiment, secondary datacenter 151 becomes the primary datacenter in response to secondary controller 152 detecting a failure of primary datacenter 101. In various examples, an instance of backup program 104 residing on secondary controller 152 operates to store data objects, recover data objects, establish referential links between data objects, send object information, receive object information, or a combination thereof. In some embodiments, computing environment 100 includes a different number of datacenters than shown in FIG. 1. In one example, computing environment 100 includes a plurality of datacenters that each include data objects (e.g., data objects 109), a controller (e.g., primary controller 102), an instance of backup program 104, and object information (e.g., object information 106), interconnected over network 110.

In one embodiment, each of object information 106 and secondary object information 156 is a data repository that may be written to and read by backup program 104. Each of data objects 109 and data objects 159 can store referential links. In one embodiment, a referential link is a reference between data objects (e.g., data objects of data objects 109, data objects 159, or both). In another embodiment, one or both of object information 106 and secondary object information 156 may be written to and read by an instance of backup program 104 stored on secondary controller 152. In some embodiments, each of object information 106 and secondary object information 156 may be written to and read by programs and entities outside of computing environment 100 in order to populate each with referential links. In the example embodiment of FIG. 1, object information 106 and secondary object information 156 are stored on primary controller 102 and secondary controller 152, respectively. In other embodiments, one or both of object information 106 and secondary object information 156 may reside on another computing device, provided that each of object information 106 and secondary object information 156 is accessible by backup program 104. In yet other embodiments, one or both of object information 106 and secondary object information 156 may be stored externally and accessed through a communication network, such as network 110.

In one embodiment, each of primary storage 108 and secondary storage 158 is a storage system. In one embodiment, a storage system includes one or more storage devices, storage media, storage arrays, or combinations thereof. In various examples, a storage system includes at least one magnetic hard disk drive, solid state hard drive, semiconductor storage device, read only memory (ROM), erasable programmable read-only memory (EPROM), flash memory, or any other computer-readable storage media that is capable of storing digital information. In one embodiment, a storage system includes one or more arrays of storage media. In various examples, the storage media are organized into an array such as a redundant array of independent disks (RAID), including without limitation RAID-0, RAID-1, RAID-5, or RAID-6, or just a bunch of disk (JBOD). Different types of storage media and different types of storage arrays can have different levels of reliability. In some cases, storage media or arrays with higher levels of reliability have lower levels of performance or decreased storage efficiency. For example, a RAID-6 array has a higher level of reliability than a RAID-0 array, but also has lower storage efficiency due to parity. In one embodiment, the level of reliability of a storage media is based on a mean time between failure (MTBF) specification or statistic of the storage media.

In one embodiment, each of data objects 109 and data objects 159 is a data repository that may be written to and read by backup program 104. Each of data objects 109 and data objects 159 can store data objects. In one embodiment, a data object includes data content and metadata. In various examples, metadata includes some or all of a category of the data content, an importance score of the object or data content, or a GUID of a replica of the object. In another embodiment, each data object includes a GUID of the data object. In another embodiment, one or both of data objects 109 and data objects 159 may be written to and read by an instance of backup program 104 stored on secondary controller 152. In some embodiments, each of data objects 109 and data objects 159 may be written to and read by programs and entities outside of computing environment 100 in order to populate each with data objects. In the example embodiment of FIG. 1, data objects 109 and data objects 159 are stored on primary storage 108 and secondary storage 158, respectively. In other embodiments, one or both of data objects 109 and data objects 159 may reside on another computing device, provided that each of data objects 109 and data objects 159 is accessible by backup program 104. In yet other embodiments, one or both of data objects 109 and data objects 159 may be stored externally and accessed through a communication network, such as network 110.

Network 110 can be, for example, a local area network (LAN), a wide area network (WAN) such as the Internet, or a combination of the two, and may include wired, wireless, fiber optic or any other connection known in the art. In general, network 110 can be any combination of connections and protocols that will support communications between primary datacenter 101 and secondary datacenter 151, in accordance with a desired embodiment of the present invention.

In various embodiments, backup program 104 operates to store data objects, recover data objects, establish referential links between data objects, send object information, receive object information, or a combination thereof. In one example, backup program 104 sends object information of object information 106 to secondary object information 156 of secondary controller 152. In another example, backup program 104 receives object information from an instance of backup program 104 stored on secondary controller 152. In yet another example, backup program 104 stores received object information to object information 106, thereby establishing a referential link between data objects. In one embodiment, backup program 104 operates to store data objects. Backup program 104 receives data content. Backup program 104 stores the received data content to an original container. Backup program 104 creates at least one replica of the object. Backup program 104 monitors requests to access the object. Backup program 104 determines a score for the object. Backup program 104 determines whether to score of the object exceeds a threshold. Backup program 104 selects a replication location. Backup program 104 replicates the object to the selected location. Backup program 104 establishes a referential link between the object and the replica. In another embodiment, backup program 104 operates to recover data objects. Backup program 104 identifies one or more objects to recover. Backup program 104 retrieves a referential link for each identified object. Backup program 104 selects a replica for recovery. Backup program 104 recovers the one or more identified objects from the selected replica of each identified object. Backup program 104 re-establishes each referential link of each recovered object. For example, backup program 104 updates object information 106 to re-establish a referential link between the recovered object and the selected replica. In one embodiment, each of a plurality of datacenters includes an instance of backup program 104 and a copy of object information 106. For example, each copy of object information 106 is synchronized regularly, periodically, or on another schedule.

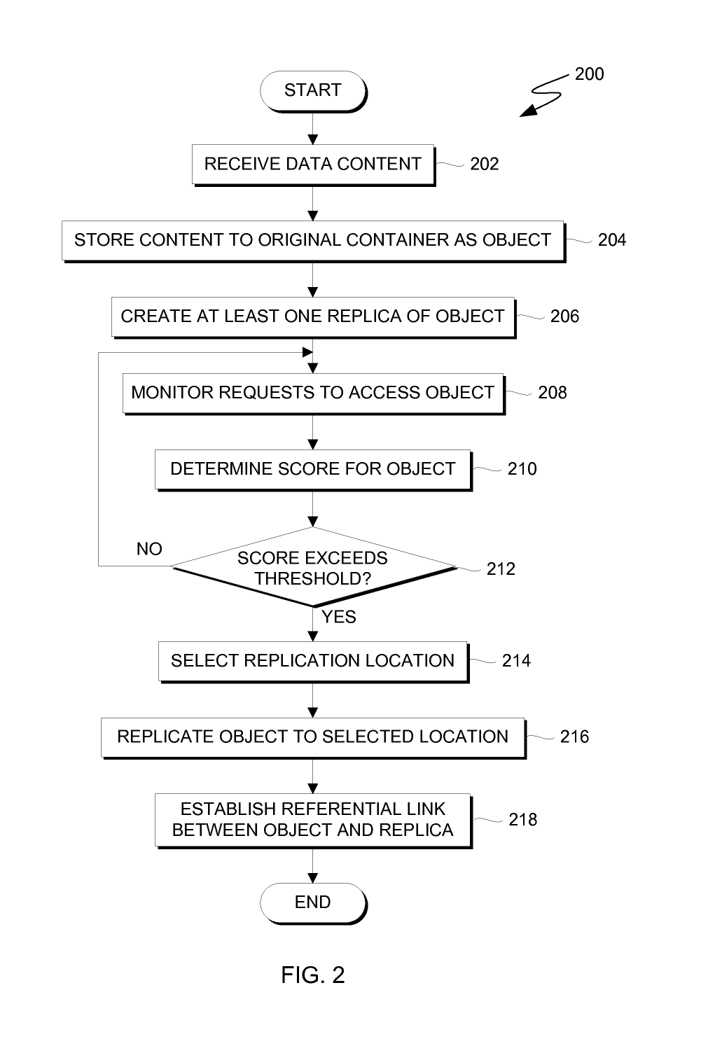

FIG. 2 is a flowchart depicting operations for storing data objects, on a computing device within the computing environment of FIG. 1, in accordance with an embodiment of the present disclosure. For example, FIG. 2 is a flowchart depicting operations 200 of backup program 104, on primary controller 102 within computing environment 100.

In step 202, backup program 104 receives data content. In one embodiment, backup program 104 receives the data content as user input via network 110. In another embodiment, the data content is associated with a user. In one example, backup program 104 receives the data content from a first user as user input via a client device (e.g., client device 121 or client device 131), in which case the data content is associated with the first user. In another example, backup program 104 receives the data content via an online social network (OSN).

In step 204, backup program 104 stores the data content to an original container as a data object. In one embodiment, backup program 104 stores the received data content to primary storage 108. For example, backup program 104 encapsulates the data content in a data object and stores the data object to data objects 109 of primary storage 108. In some embodiments, primary storage 108 includes one or more containers, each of which is a portion of storage for electronic data. In one such embodiment, each data object of data objects 109 is stored within a container of primary storage 108. In another embodiment, each container is associated with a user. For example, primary storage 108 includes one or more containers, each of which is associated with a user of an OSN. In one embodiment, the original container is a container of primary storage 108 that is associated with a user with whom the data content is associated. For example, backup program 104 receives data content from a user (see step 202) and stores the data content to a container of the user.

In step 206, backup program 104 creates at least one replica of the object. A replica is an object that includes the same user data as another object. In one embodiment, backup program 104 creates a replica of the object by replicating the object to another datacenter. For example, backup program 104 replicates an original object by creating a replica object that includes the same user data as the original object and storing the replica object to a storage system. In one embodiment, backup program 104 selects the other datacenter based on geographic location of the datacenters. For example, backup program 104 replicates the object to the datacenter that is geographically located farthest away from the datacenter relative to each other datacenter. In this example, backup program 104 creates at least one replica of an object of data objects 109 by determining the geographic distance between primary datacenter 101 and each other datacenter (e.g., secondary datacenter 151). Replicating the object to the datacenter that is farthest away from primary datacenter 101 can decrease the likelihood that a single geographically localized environmental event will affect both replicas of the object. In another embodiment, backup program 104 creates a replica of the object on a datacenter that is selected based on a different metric (e.g., amount of free space available, ratio of storage utilization, overall number of accesses) or on a datacenter that is selected arbitrarily.

In step 208, backup program 104 monitors requests to access the object. In various embodiments, backup program 104 monitors requests to access one or more of the original object and each replica of the original object. In one embodiment, backup program 104 receives requests to access the object via network 110. In various examples, backup program 104 receives requests to access the object from other datacenters (e.g., secondary datacenter 151), client devices (e.g., client device 121 or client device 131), or other computing devices (not shown). In one example, a first user, being a user of client device 121, provides an image (i.e., data content) (see step 202) to primary datacenter 101. Backup program 104 stores the image, at least in part, as an object of data objects 109 in a container associated with the first user. Backup program 104 monitors requests to access the object. The image is shared by the first user via an OSN, of which the first user and a second user, being a user of client device 131, are members. The second user, located geographically proximate to secondary datacenter 151, attempts to view the data content. In response, primary datacenter 101 receives a request from secondary datacenter 151 for access to the object. Backup program 104 detects the request to access the object.

In step 210, backup program 104 determines a score for the object. The score represents a measure of importance of the object. In one embodiment, backup program 104 determines the score based on one or more factors. Such factors include, in various examples, a count of requests for access, the geographic location from which each request for access is received, the relationship between the requestor (i.e., the user that initiated the request for access) and the object owner (i.e., the user in whose container the requested object is stored), the category of the data content of the object, and frequency of requests for access within a particular time frame. For example, backup program 104 determines the score for an object stored in a datacenter located within Region A based on factors including the count of requests to access the object and the location from which the requests for access are received. In this example, backup program 104 monitors requests for access for the object that include ten requests from locations within region A, twenty requests from locations within Region B, and five requests from locations within Region C. Based on these factors, backup program 104 determines a score of twenty-five, being the sum of the total count of requests for access from locations other than locations within the region in which the object is stored. In one embodiment, the score of the object is determined and updated continuously based on such factors. In another example, backup program 104 determines the score for an object stored in data objects 159 based on the relationship between the requestor and the object owner. The requestor and the object owner are each members of an OSN and are connected via a mutual friend. Based on the connections of the OSN, backup program 104 determines that the requestor and the object owner have two degrees of separation. In one embodiment, the score is proportional to the degree of separation. For example, backup program 104 determines a higher score for an object that is referenced with a higher degree of separation and a lower score for an object that is referenced with a lower degree of separation. Thus, the deemed importance of an object increases as the object is accessed by a wider variety of users. In an alternative embodiment, the score is inversely proportional to the degree of separation. For example, backup program 104 determines a lower score for an object that is referenced with a higher degree of separation and a higher score for an object that is referenced with a lower degree of separation.

In some embodiments, backup program 104 determines a score for the object based on requests for access received by any datacenter. For example, backup program 104 determines a score for an object, a first copy (i.e., an original) of which is stored in data objects 109 and a second copy (i.e., a replica) of which is stored in data objects 159. Backup program 104 monitors requests to access the first copy and to the second copy. Backup program 104 determines a score for the object based on all of the requests to access the object.

In some embodiments, backup program 104 determines a score for each object of each data object repository. For example, an original object is stored in data objects 109 and a replica is stored in data objects 159. Primary datacenter 101 and secondary datacenter 151 receive requests to access the original object and the replica, respectively. Backup program 104 determines a first score for the original object and a second score for the replica of the object based on the respective requests to access each object. In one such embodiment, backup program 104 stores the first score and the second score to metadata of the original object and the replica of the object, respectively.

In some embodiments, backup program 104 determines a score for each object and any replicas of the object, collectively. For example, an original object is stored in data objects 109 and a replica is stored in data objects 159. Primary datacenter 101 and secondary datacenter 151 receive requests to access the original object and the replica, respectively. Backup program 104 determines a score based on the accesses to the original object and the replica. In one such embodiment, backup program 104 stores the score to the metadata of the original object and the metadata of the replica. Continuing the previous example, backup program 104 stores the score to the metadata of both of the original object of data objects 109 and the replica of data objects 159.

In some embodiments, backup program 104 stores the determined score to an object information repository. For example, backup program 104 stores the determined score for an object to object information 106 in a record that also includes an identifier, such as a GUID, of the object. In one embodiment, backup program 104, in response to modifying object information 106, sends the changes to secondary object information 156. For example, backup program 104 pushes an update to secondary object information 156, wherein the update identifies the modifications made to object information 106. In another embodiment, backup program 104 updates secondary object information 156 by sending a batch of updates to secondary datacenter 151 periodically or routinely. For example, a batch of updates is sent once per twenty-four hour time period. In another example, a batch of updates is sent routinely based on a level of network or storage access activity falling below a predetermined threshold. In some embodiments, backup program 104 sends the updates to an instance of backup program 104 stored on secondary controller 152. For example, each instance of backup program 104 sends updates to each other instance of backup program 104.

In decision 212, backup program 104 determines whether the score of the object exceeds a threshold. In various embodiments, the threshold is pre-determined, algorithmically determined, or determined based on user input. In one embodiment, backup program 104 determines whether to replicate the object based on whether the score of the object exceeds the threshold. If backup program 104 determines that the score does exceeds the threshold (decision 212, YES branch), then backup program 104 determines a replication location (step 214). If backup program 104 determines that the score does not exceed the threshold (decision 212, NO branch), then backup program 104 continues to monitor requests to access the object (step 208). In one embodiment, backup program 104 continues to monitor requests to access an object until the score of the object exceeds the threshold, at which point backup program 104 determines a replication location (step 214). In one embodiment, the value of the threshold varies based on the number of replicas. For example, the threshold is higher for an object that has four replicas than for an object that has one replica.

In some embodiments, backup program 104 continuously updates the score for an object (step 210) and determines whether the score exceeds the threshold (decision 212). In some such embodiments, backup program 104 determining whether the score exceeds a threshold includes determining whether the score exceeds a replication threshold and determining whether the score falls below a de-replication threshold. The de-replication threshold is a threshold with a value other than that of the replication threshold. Each threshold is, in various embodiments, pre-determined, algorithmically determined, or determined based on user input. If backup program 104 determines that the score falls below the de-replication threshold, then backup program 104 removes (e.g., deletes) a replica from a datacenter. However, in one embodiment, backup program 104 maintains a minimum number (e.g., one) of replicas, regardless of the score of the object. For example, backup program 104 replicates an object based on the score of the object exceeding the replication threshold and subsequently de-replicates the object based on the score of the object falling below a de-replication threshold for a particular period of time.

In step 214, backup program 104 selects a replication location. In one embodiment, the replication location includes both a datacenter and a container. For example, the replication location includes a datacenter at which to create a replica and a container of the datacenter in which to store the replica. In one embodiment, backup program 104 disregards (i.e., does not select) any datacenter at which the original object or a replica of the object is already stored. In one embodiment, backup program 104 selects a container of the datacenter based on a level of reliability of the container. For example, a datacenter has a first container with 99.99% uptime and a second container with 99.9999% uptime. In this case, backup program 104 selects a container with a high level of uptime for an object with a high score. Backup program 104 thereby stores objects with scores indicating increased importance in containers with levels of reliability indicating a lower risk of data loss. In one embodiment, backup program 104 selects a datacenter based on the location of the requests to access the object. For example, backup program 104 determines the datacenter that is closest to the location of each request and selects the datacenter that is closest to the greatest number of requests. In another example, backup program 104 determines an average location and selects the datacenter closest to the average location. The average location has an average longitude and an average latitude, determined by averaging the longitude and latitude, respectively, of each request location.

In step 216, backup program 104 replicates the object to the selected location. In one embodiment, backup program 104 replicates the object by storing the object to the data objects repository of the selected location. For example, backup program 104 stores the object to the first container of data objects 159 of secondary datacenter 151.

In some embodiments, a maximum number of replicas is configured. In various embodiments, the maximum number of replicas may be predetermined, algorithmically determined, or determined based on user input. In one embodiment, backup program 104 removes replicas or prevents the storage of additional replicas in order to store the maximum number of replicas or fewer. In another embodiment, backup program 104 removes a replica from a datacenter. For example, in response to replicating the object to the selected location (step 216), backup program 104 removes a replica from another datacenter. The other datacenter is, in various examples, a datacenter within a geographic region with the least number of requests to access the object, a datacenter in which backup program 104 created the at least one replica (see step 206), a datacenter with the lowest ratio of free storage space available relative to the other datacenters, or an arbitrarily selected datacenter.

In step 218, backup program 104 establishes a referential link between the object and the replica. In one embodiment, backup program 104 establishes the referential link by storing a reference to an object information repository. In various embodiments, the reference is unidirectional (e.g., from the replica to the object or from the object to the replica), bidirectional (e.g., between the replica and the object), or directionless (e.g., between the replica and the object). For example, backup program 104 replicates an object of data objects 109 to data objects 159 and stores a reference to object information 106 that establishes a referential link between the object of data objects 109 and the replica of data objects 159. In some embodiments, backup program 104 stores the referential link to a first object information repository (e.g., object information 106) and, in response, updates a second object information repository (e.g., secondary object information 156). For example, backup program 104 updates the second object information repository as discussed above (see step 210). In some embodiments, the referential link identifies a user in whose container the object is stored and a user in whose container the replica is stored. In one embodiment, the user in whose container the replica is stored is a user who initiated a request for access to the object.

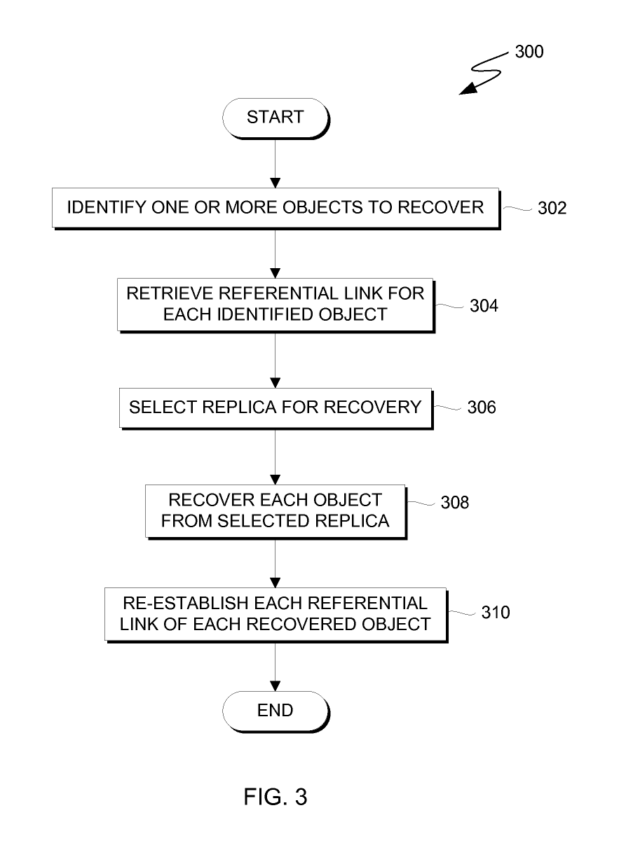

FIG. 3 is a flowchart depicting operations for restoring a data object, on a computing device within the computing environment of FIG. 1, in accordance with an embodiment of the present disclosure. For example, FIG. 3 is a flowchart depicting operations 300 of backup program 104, on primary controller 102 within computing environment 100.

In step 302, backup program 104 identifies one or more objects to recover. In one embodiment, backup program 104 identifies objects that are no longer accessible. In various embodiments, an object may become inaccessible due to a failure of the storage system in which the object is stored, due to an accidental deletion of the object, due to corruption of data, or for other reasons that may be hardware-related, software-related, or a combination thereof. In one example, a first data object of primary storage 108 becomes corrupted. In this case, backup program 104 identifies the first data object as a data object to recover. In another example, primary storage 108 of primary datacenter 101 experiences a complete failure, and data objects 109 are lost. In this case, backup program 104 identifies the objects of data objects 109 as the one or more objects to recover. For example, backup program 104 identifies a data object as an object to recover based on a determination that the data object is inaccessible using the GUID of the data object as stored in an object information repository.

In step 304, backup program 104 retrieves a referential link for each identified object. In one embodiment, each referential link includes a GUID of the identified object, a GUID of a replica of the identified object, and a location at which the replica is stored. In various embodiments, the location identifies a datacenter, a container, or both. For example, the location identifies a datacenter and a container of the datacenter. In one embodiment, backup program 104 retrieves each referential link from an object information repository. For example, backup program 104 retrieves each referential link from object information 106 or, alternatively, from secondary object information 156. In another embodiment, object information 106 is inaccessible, at least to the extent necessary for backup program 104 to retrieve each referential link. In this case, for example, backup program 104 retrieves each referential link from secondary object information 156 and restores the referential links of object information 106 based on secondary object information 156.

In some embodiments, object information 106 is stored to primary storage 108. In an example of one such embodiment, primary storage 108 fails, and data objects 109 and object information 106 both become inaccessible. In this case, backup program 104 identifies each of data objects 109 as the objects to recover and retrieves the referential link for each identified object from secondary object information 156. Alternatively, in this case, backup program 104 determines that object information 106 is inaccessible, and, in response, recovers the referential links of object information 106 based on secondary object information 156.

In step 306, backup program 104 selects a replica for recovery. In one embodiment, each identified object has one or more referential links, each of which reference a replica of the object. Backup program 104 selects a replica for recovery from among the replicas of the object referenced by the one or more referential links. In one embodiment, backup program 104 selects a replica based on a characteristic of the datacenter in which the replica is stored. In various examples, backup program 104 selects a replica based on the level of network activity of the datacenter, the level of storage access activity of the datacenter, the geographic location of the datacenter, or the throughput of the connection via network 110 between the datacenter of the replica and the datacenter to which the replica is being restored. In another embodiment, backup program 104 selects a replica based on a characteristic of the replica. In various examples, backup program 104 selects a replica based on the degree of separation between the requestor and the owner, based on the order in which the replicas were created, or based on the number of referential links corresponding to each replica.

In step 308, backup program 104 recovers the one or more identified objects from the selected replica of each identified object. In one embodiment, backup program 104 recovers an identified object based on the selected replica. For example, backup program 104 recovers an identified object of data objects 109 based on a selected replica of data objects 159 by storing a copy of the selected replica to data objects 109. In one embodiment, backup program 104 assigns the GUID of the identified object to the recovered object. For example, a first data object of data objects 109 has a first GUID. The first data object becomes inaccessible due to a hardware failure of primary storage 108. Backup program 104 recovers the first data object by retrieving a first replica of the first data object from data objects 159 and storing a copy of the first replica to data objects 109 as a recovered data object. In this example, backup program 104 assigns the first GUID to the recovered data object. Alternatively, backup program 104 generates a new GUID and assigns the new GUID to the recovered data object. In one embodiment, backup program 104 updates at least one object information repository based on the assigned GUID. For example, backup program 104 updates object information 106. In another example, backup program 104 updates object information 106 and an object information repository of another datacenter, such as secondary object information 156 of secondary datacenter 151.

In step 310, backup program 104 re-establishes each referential link of each recovered object. In one embodiment, backup program 104 updates each referential link of an identified object with the GUID and location of the recovered object. For example, backup program 104 determines that a first object of data objects 109 is inaccessible. Backup program 104 retrieves a referential link for the first object from object information 106. The referential link includes a GUID and location of each of the first object and a second object, which is a replica of the first object. Backup program 104 recovers the first object by replicating the second object to data objects 109. Backup program 104 updates the referential link of object information 106 with the GUID and location of the recovered object.

FIG. 4 is a block diagram of components of the computing device executing operations for storage and recovery of data objects, in accordance with an embodiment of the present disclosure. For example, FIG. 4 is a block diagram of primary controller 102, client device 121, client device 131, or secondary controller 152 within computing environment 100 executing operations of backup program 104.

It should be appreciated that FIG. 4 provides only an illustration of one implementation and does not imply any limitations with regard to the environments in which different embodiments may be implemented. Many modifications to the depicted environment may be made.

Each of primary controller 102, client device 121, client device 131, or secondary controller 152 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Each of backup program 104, object information 106, and secondary object information 156 is stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of network 110. In these examples, communications unit 410 includes one or more network interface cards.

Communications unit 410 may provide communications through the use of either or both physical and wireless communications links. Each of backup program 104, object information 106, and secondary object information 156 may be downloaded to persistent storage 408 through communications unit 410.

I/O interface(s) 412 allows for input and output of data with other devices that may be connected to each of primary controller 102, client device 121, client device 131, or secondary controller 152. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention (e.g., backup program 104, object information 106, secondary object information 156) can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The term(s) “Smalltalk” and the like may be subject to trademark rights in various jurisdictions throughout the world and are used here only in reference to the products or services properly denominated by the marks to the extent that such trademark rights may exist.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for storing and recovering data objects, the method comprising:
storing, by one or more processors, a first data object to a first storage system, wherein the first data object includes user data;
determining, by one or more processors, a score of the first data object, wherein the score of the first data object represents an importance of the first data object;
responsive to determining, by one or more processors, that the score of the first data object exceeds a threshold, storing, by one or more processors, a second data object to a second storage system, wherein the second data object includes the user data; and
storing, by one or more processors, to a first reference database a reference of the second data object and the first data object.

2. The method of claim 1, further comprising:
storing, by one or more processors, a third data object to a third storage system, wherein the third data object includes second user data;
determining, by one or more processors, that the third data object is inaccessible;
retrieving, by one or more processors, a reference between the third data object and a fourth data object, wherein the fourth data object includes the second user data; and
storing, by one or more processors, a recovered data object to the third storage system based on the fourth data object, wherein the recovered data object includes the second user data.

3. The method of claim 1, further comprising:
receiving, by one or more processors, one or more requests to access the first data object, wherein the score of the first data object is based, at least in part, on the one or more requests to access the first data object.

4. The method of claim 3, wherein the score of the first data object is based, at least in part, on a count of the one or more requests for access to the first data object and a geographic location of each of the one or more requests for access to the first data object.

5. The method of claim 1, further comprising:
updating, by one or more processors, a second reference database of a second datacenter in response to storing the reference to the first reference database, wherein the second datacenter includes the second storage system, and wherein a first storage system includes the first storage system and the first reference database.

6. The method of claim 1, wherein the reference of the second data object and the first data object identifies a first global unique identifier of the first data object and a second global unique identifier of the second data object.

7. The method of claim 1, wherein storing the second data object to the second storage system further comprises:
selecting, by one or more processors, a container of the second storage system based, at least in part, on the score of the first data object and a level of reliability of the container.

8. The method of claim 1, further comprising:
determining, by one or more processors, a geographical distance between each of a plurality of storage systems and the first storage system;
selecting, by one or more processors, a third storage system of the plurality of storage systems based on the geographical distance of the third storage system being greater than the geographical distance of each other storage system of the plurality of storage systems; and
responsive to determining, by one or more processors, that a count of data objects that include the user data fails to exceed a minimum threshold, storing, by one or more processors, a third data object to the third storage system, wherein the third data object includes the user data.

9. A computer program product for storing and recovering data objects, the computer program product comprising:
a computer readable storage medium and program instructions stored on the computer readable storage medium, the program instructions comprising:
program instructions to store a first data object to a first storage system, wherein the first data object includes user data;
program instructions to determine a score of the first data object, wherein the score of the first data object represents an importance of the first data object;
program instructions to, responsive to determining that the score of the first data object exceeds a threshold, store a second data object to a second storage system, wherein the second data object includes the user data; and
program instructions to store to a first reference database a reference of the second data object and the first data object.

10. The computer program product of claim 9, wherein the program instructions further comprise:
program instructions to store a third data object to a third storage system, wherein the third data object includes second user data;
program instructions to determine that the third data object is inaccessible;
program instructions to retrieve a reference between the third data object and a fourth data object, wherein the fourth data object includes the second user data; and
program instructions to store a recovered data object to the third storage system based on the fourth data object, wherein the recovered data object includes the second user data.

11. The computer program product of claim 9, wherein the program instructions further comprise:
program instructions to receive one or more requests to access the first data object, wherein the score of the first data object is based, at least in part, on the one or more requests to access the first data object.

12. The computer program product of claim 11, wherein the score of the first data object is based, at least in part, on a count of the one or more requests for access to the first data object and a geographic location of each of the one or more requests for access to the first data object.

13. The computer program product of claim 9, wherein the program instructions further comprise:
program instructions to update a second reference database of a second datacenter in response to storing the reference to the first reference database, wherein the second datacenter includes the second storage system, and wherein a first storage system includes the first storage system and the first reference database.

14. The computer program product of claim 9, wherein the reference of the second data object and the first data object identifies a first global unique identifier of the first data object and a second global unique identifier of the second data object.

15. A computer system for storing and recovering data objects, the computer system comprising:
one or more computer processors;
one or more computer readable storage media;
program instructions stored on the computer readable storage media for execution by at least one of the one or more processors, the program instructions comprising:
program instructions to store a first data object to a first storage system, wherein the first data object includes user data;
program instructions to determine a score of the first data object, wherein the score of the first data object represents an importance of the first data object;
program instructions to, responsive to determining that the score of the first data object exceeds a threshold, store a second data object to a second storage system, wherein the second data object includes the user data; and
program instructions to store to a first reference database a reference of the second data object and the first data object.

16. The system of claim 15, wherein the program instructions further comprise:
program instructions to store a third data object to a third storage system, wherein the third data object includes second user data;
program instructions to determine that the third data object is inaccessible;
program instructions to retrieve a reference of the third data object and a fourth data object, wherein the fourth data object includes the second user data; and
program instructions to store a recovered data object to the third storage system based on the fourth data object, wherein the recovered data object includes the second user data.

17. The system of claim 15, wherein the program instructions further comprise:
program instructions to receive one or more requests to access the first data object, wherein the score of the first data object is based, at least in part, on the one or more requests to access the first data object.

18. The system of claim 17, wherein the score of the first data object is based, at least in part, on a count of the one or more requests for access to the first data object and a geographic location of each of the one or more requests for access to the first data object.

19. The system of claim 15, wherein the program instructions further comprise:
program instructions to update a second reference database of a second datacenter in response to storing the reference to the first reference database, wherein the second datacenter includes the second storage system, and wherein a first storage system includes the first storage system and the first reference database.

20. The system of claim 15, wherein the reference identifies a first global unique identifier of the first data object and a second global unique identifier of the second data object.
